(19) United States
(12) Patent Application Publication
(10) Pub. No.: US 2025/0386062 A1
(43) Pub. Date: Dec. 18, 2025

(54) PREDICTIVE CONTENT PRELOADING

(71) Applicants: Lemon Inc., Cayman Islands (KY); Beijing Zitiao Network Technology Co., Ltd., Beijing (CN)

(72) Inventors: Dian Yang, Singapore (SG); Xiaowei Li, Beijing (CN); Wei Zeng, Beijing (CN); Shan Zhang, Culver City, CA (US); Shenglan Huang, Culver City, CA (US); Rui Ding, Singapore (SG); Songkai JIA, Beijing (CN)

(21) Appl. No.: 19/240,843

(22) Filed: Jun. 17, 2025

Related U.S. Application Data
(63) Continuation of application No. PCT/CN2024/099961, filed on Jun. 18, 2024.

(51) Int. Cl. H04N 21/2187; H04N 21/466

(52) U.S. Cl. CPC H04N 21/2187; H04N 21/4665

(57) ABSTRACT

Methods, systems, and apparatus, including computer programs encoded on computer storage media, for predictive content preloading. One of the methods includes obtaining data indicating an ordered first set of digital content to provide to a user device, the ordered first set of digital content comprising (i) one or more prerecorded videos and (ii) a live video feed, wherein the live video feed follows the one or more prerecorded videos in the ordered first set of digital content; generating preloading data using prediction data indicating how long a user of the user device is likely to watch the one or more prerecorded videos; using the generated preloading data, determining preloading of the live video feed included in the ordered first set of digital content; and providing, using the determined preloading, data of the live video feed to the user device.

### CROSS-REFERENCE TO RELATED APPLICATIONS

This application is a continuation application of PCT Application No. PCT/CN2024/099961, filed on Jun. 18, 2024, the disclosure of the aforementioned application is hereby incorporated by reference in its entirety.

### BACKGROUND

Online platforms provide content, including video content, to a user. Before being displayed on a user device, the content can be obtained from another source, such as a server. Obtaining content in preparation for viewing can be referred to as loading.

### SUMMARY

In some cases, users can receive, via user devices, a feed of video content that includes both prerecorded and live video content. Prerecorded videos can be preloaded at any time, e.g., in device memory cache. But live videos are different. Because they are played live, a current frame must be repeatedly fetched to effectively preload the live video. This fetching can significantly impact network bandwidth and makes preloading too early—e.g., before a request for viewing by a user-which may be especially costly for live videos. The techniques describe methods to help reduce bandwidth and latency for preloading live video content for user devices, e.g., using preloading predictions generated by a machine leaning model.

In general, one aspect of the subject matter described in this specification can be embodied in methods that include the actions of obtaining data indicating an ordered first set of digital content to provide to a user device, the ordered first set of digital content comprising (i) one or more prerecorded videos and (ii) a live video feed, wherein the live video feed follows the one or more prerecorded videos in the ordered first set of digital content; generating preloading data using prediction data indicating how long a user of the user device is likely to watch the one or more prerecorded videos; using the generated preloading data, determining preloading of the live video feed included in the ordered first set of digital content; and providing, using the determined preloading, data of the live video feed to the user device.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. Feature 1: Generating the preloading data includes generating a classification for the one or more prerecorded videos in the ordered first set of digital content. Feature 2: Generating the classification includes: determining whether or not the user of the user device is likely to watch the one or more prerecorded videos for a specified period of time. Feature 3: Generating the preloading data includes: generating a first classification for the one or more prerecorded videos in the ordered first set of digital content indicating whether or not the user of the user device is likely to watch the one or more prerecorded videos for a first specified period of time; in response to the first classification indicating that the user of the user device is likely to watch the one or more prerecorded videos for more than or equal to the specified period of time, waiting for a waiting duration period; and after waiting for the waiting duration period, generating a second classification for the one or more prerecorded videos in the ordered first set of digital content indicating whether or not the user of the user device is likely to watch the one or more prerecorded videos for a second specified period of time. Feature 4: The waiting duration period is equal to the first specified period of time. Feature 5: Generating the preloading data includes generating the preloading data using a machine learning model trained to predict an indication of how long the user of the user device is likely to watch the one or more prerecorded videos. Feature 6: Actions include training the machine learning model using training data that includes (i) user associated data for users that have watched one or more videos, (ii) data representing features of the one or more videos, and (iii) ground truth data representing known watch times for the one or more videos by the users represented in the user associated data. Feature 7: Actions include providing at least a portion of the one or more prerecorded videos to the user device while providing the data of the live video feed to the user device. Feature 8: Actions include providing at least a portion of the one or more prerecorded videos to the user device prior to providing the data of the live video feed to the user device.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The subject matter described in this specification can be implemented in various implementations and may result in one or more of the following advantages. Techniques can include predictive preloading of videos, such as live videos, which allows online platforms to reduce bandwidth and associated processing of data by minimizing the amount of time spent preloading. Live video feeds can require a system to continually refresh a current starting frame so that, when shown, the video is showing a current frame and not showing a past frame. Techniques described improve user experience by preloading live video which allows the live video to start playing, e.g., after a previous video, with less delay compared to no preloading. Techniques described can improve user experience while reducing bandwidth and processing requirements by predicting when to start preloading so as to minimize the amount of time and resources spent preloading.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example platform system.

FIG. 2 shows an example of a system for predictive content preloading.

FIG. 3 is a flowchart of an example preloading process.

FIG. 4 is a block diagram of a computing system that can be used in connection with computer-implemented methods described in this specification.

Like reference numbers and designations in the various drawings indicate like elements.

### DETAILED DESCRIPTION

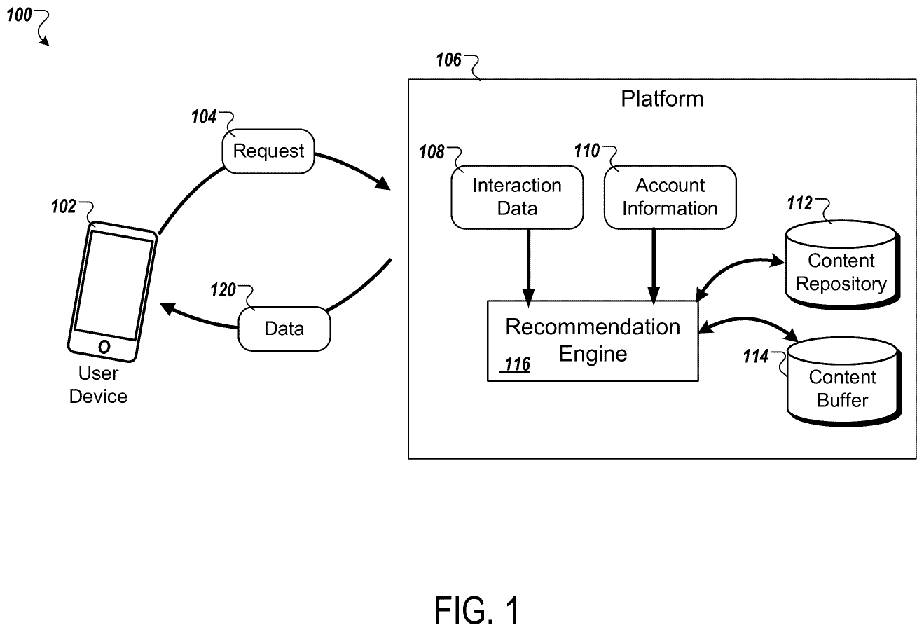

FIG. 1 shows an example platform system 100. The system 100 can provide user-specific content to the user device 102 in response to a received request 104. The request can be sent by the user device 102 in response to a user opening an application, e.g., running on the user device 102, or interacting with an ongoing instance of an application.

The system 100 includes a user device 102 and a platform 106. The user device 102 can be a mobile computing device, such as a smartphone. The platform 106 can operate on the user device 102, one or more computers external to the user device-such as servers, distributed networks, or the like—or a combination of one or more of these. The platform 106 can operate on one or more processors configured to perform operations described in reference to the platform 106 of FIG. 1.

The user device 102 sends the request 104 to the platform 106. In cases where the platform 106 is external to the user device 102, the request 104 can be sent over a suitable data network, such as Wi-Fi, 5G, or Ethernet, from the user device 102 to the platform 106. In some cases, the platform 106 can use suitable networks to provide data between two or more elements of the platform 106. In some cases, the user device 102 sends the request 104 to the platform 106 operating internally using processors and connected components of the user device 102.

Each user device, such as the user device 102, can be configured with software that in operation can access a streaming service, e.g., of the platform 106. A user can interact with the streaming service using a device. For example, the device can use software to upload video content to the streaming service as well as receive videos from the streaming service. The software can be a specific application of the streaming service installed on the device. The streaming service can be, for example, an online social media platform.

In some implementations, the software provides a user interface for interacting with the streaming service. The user interface can include receiving data from the streaming service for presenting a feed of videos that the user can interact with. For example, the user can scroll up or down to switch between videos in the feed as well as interact with individual videos, e.g., by posting comments about the video, sharing the video, or expressing approval, e.g., liking the video.

In some implementations, the video content provided by the streaming service to user devices are short-form videos. Short-form videos are videos that are typically less than 90 seconds in length. In some implementations, short-form videos have lengths of between 15 and 90 seconds. By contrast, long-form videos typically have lengths of at least 3 minutes.

The platform 106 receives the request 104. The request 104 can include a request for specific content, such as a specific video or content page, or a general request. The platform 106 can generate and provide data 120 to be displayed on the user device 102.

In some cases, the platform 106 recommends specific content for a specific user, e.g., based on data associated with the user. For example, the platform 106 can include a recommendation engine 116. The recommendation engine 116 can determine content that is likely to be of interest to a user, e.g., that the user is likely to find useful or appealing. The recommendation engine 116 can use data associated with a user to determine content for a given user. In some cases, the recommendation engine 116 uses interaction data 108 and account information 110 to determine content for a given user. The interaction data 108 can include representations of one or more interactions taken by a user of the user device 102, e.g., using a graphical user interface displayed on the user device 102. The account information 110 can include information, such as demographic information, interests, or historical data associated with a user.

In the example of FIG. 1, the recommendation engine 116 uses the interaction data 108 and the account information 110 to generate and provide the data 120 to the user device. The recommendation engine 116 can include one or more machine learning models that have been trained to predict content that will be useful or appealing to a user—e.g., based on interaction or viewing duration metrics. The recommendation engine 116 can use training data that includes data associated with a user and an indication of whether or not recommended content resulted in positive or negative impacts on engagement, such as interaction or viewing duration metrics.

In some cases, one or more models of the recommendation engine 116 are trained online—e.g., using feedback from real users after devices of the real users have obtained recommended content from the recommendation engine 116. For example, the recommendation engine 116 can provide recommended content and the platform 106 can record subsequent actions by a user to determine if the recommended content was a good or bad recommendation where good can represent content that increases user engagement or is labeled by a user as helpful or appealing and bad can represent content that decreases user engagement or is labeled by a user as not helpful or appealing.

In some cases, the recommendation engine 116 provides data from a content repository 112 or a content buffer 114. For example, the content repository 112 can include content recorded by users of the platform 106, or other instances of the platform 106, and uploaded to servers associated with the platform 106. The content can include videos uploaded by users. The content repository 112 can be stored, at least partially, in memory of the user device 102. For example, the user device 102 can store content for offline viewing or content that the user uploaded.

The content buffer 114 can include live content being streamed by users. For example, live recordings made by users can be uploaded to the platform 106, or other instances of the platform 106, as the content is being created. In the case of videos, the content can include frames of video uploaded for viewing as they are captured by a recording device. The platform 106 can access live video streams included in the content buffer 114 and provide the data to the user device 102. In some cases, the content buffer 114 is stored, at least partially, in memory of the user device 102. For example, the content buffer 114 can include loaded live or prerecorded data that will be shown on a display of the user device 102 at a particular time or in response to one or more specific interactions by a user of the user device 102, e.g., a swiping up motion on a touch screen.

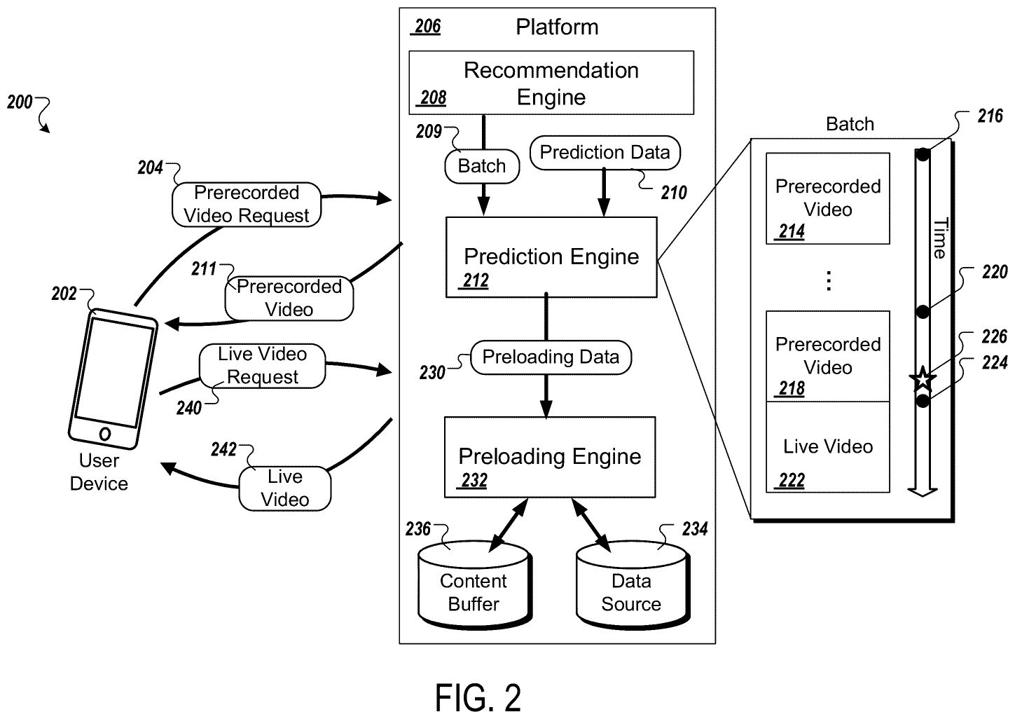

FIG. 2 shows an example of a system 200 for predictive content preloading. The system 200 can preload content before the content is specifically requested for being viewed or consumed in a way that minimizes latency for a user and bandwidth and processing of the system 200. The system 200 includes a user device 202 and a platform 206. The platform can be a version of the platform 106 of FIG. 1. The platform 206 can determine preloading for content—e.g., determining whether or when to preload one or more videos on the user device 202. The preloading determination can be optimized to help reduce bandwidth or processing of content—e.g., reducing the amount of current frames of a live video that are loaded into a buffer of the user device 202. If a live video is preloaded too early, latency for playing the live video after a previous video can be reduced but bandwidth is needlessly increased because, in order to play live, the live video is continually refreshed. If a live video is preloaded too late, bandwidth can be reduced but latency increases—e.g., a user waits after the end of a previous video for the preloading of the live video to finish, or start and finish. The techniques described in this application help to achieve optimal, or near optimal, preloading to help reduce bandwidth usage and latency.

The system 200 can be similar to the system 100 of FIG. 1 in that the user device 202 can send requests to the platform 206 as the user device 102 sends requests to the platform 106 described in reference to FIG. 1. The system 200 of FIG. 2 is used to show the techniques of predictive content preloading that can be used by a system, such as the system 100.

In general, the user device 202 requests content from the platform 206. The content can include a batch of videos. The batch of videos can include one or more prerecorded videos and one or more live videos. For example, the batch of videos can include a sequence of prerecorded videos followed by a live video. The techniques described can reduce the processing and bandwidth required for preloading the live video in the batch of videos. Live videos are distinct from prerecorded videos in that new frames are being uploaded, e.g., to the platform 206 or another instance, and to show the live video on the user device 202 the new frames need to be transmitted to the user device 202. The sending, storing, and rendering of new frames uses network bandwidth and processing resources on the user device 202 and connected components—e.g., which can, at least partially, perform operations of the platform 206. To reduce latency in responding to a request for a live video in a batch of videos, the system 200 can use a prediction engine 212 to determine a preloading operation that helps to reduce the number of live video frames transmitted and stored at the user device 202 in anticipation of the live video being requested for playing.

The user device 202 generates and transmits a prerecorded video request 204 and, subsequently, a live video request 240 to the platform 206. The prerecorded video request 204 can represent a user interacting with an interface of the user device 202, e.g., a graphical user interface, to initiate the display of a prerecorded video. In some cases, the user device 202 generates and transmits the prerecorded video request 204 in response to a user interacting with an interface of the user device 202. An interaction with the interface can include swiping or tapping on a touch screen of the interface. An interaction with the interface can include inaction—e.g., not touching or swiping for a predetermined period of time.

The prerecorded video request 204 can be subsequent to an initial request—e.g., sent upon launching an application of the user device 202 used for interface and displaying content—for content, such as a batch of videos. For example, the user device 202 can submit a general request for videos to the platform 206. The recommendation engine 208 of the platform 206 can generate a batch 209 that includes content for the user device 202. The content can include a set of one or more prerecorded videos and one or more live videos. In response to receiving prerecorded video request 204, the platform 206 can provide the prerecorded video 211, where the prerecorded video 211 is included in the batch 209. The prerecorded video request 204 can be automatically sent by the user device 202 after a user launches an application or in response to a user performing an interaction, such as swiping up on a touch screen.

In some cases, the content used for predictive content preloading is not generated by a recommendation engine. For example, the content used for predictive content preloading can be selected by a user—e.g., selecting a set of one or more content items which can be predictively preloaded as described in this document with reference to the batch 209. The content can be selected by the platform 206 without using one or more machine learning models. For example, the content can be a predetermined set of content provided to one or more devices irrespective of particular user associated data—e.g., for an initial use of an application.

The prediction engine 212 can determine one or more preloading operations for preloading content. For example, the prediction engine 212 can determine a preloading start time 226 for live video 222 included in the batch 209. The start times of videos in the batch 209 are shown graphically for ease of explanation. In particular, the prerecorded video 214 is displayed on a screen of the user device 202 at a first start time 216, the prerecorded video 218 is displayed on a screen of the user device 202 at a second start time 220 subsequent to the first start time 216, and the live video 222 is displayed at a third start time 224. The preloading start time 226 represents the time at which the platform 206 begins preloading the live video 222 so that, when requested by the user device 202, the live video 222 can be seamlessly displayed. The prediction engine 212 can determine when, or if, this preloading occurs.

The prediction engine 212, in determining preloading, can use content queued for the user device 202 and prediction data 210 that can include data associated with a user of the user device 202, such as demographic data, account information, interaction during a current session, historical interaction data, viewing history, among others. The prediction engine 212 can include one or more machine learning models trained to predict preloading of content.

The prediction engine 212 can use one or more classifier or regression models for predicting preloading of content. In some cases, one or more models of the prediction engine 212 are trained as regression models that predict a watch time of a video, e.g., the video 218 prior to the live video 222. Using the predicted watching time, the platform can start preloading so that content is loaded and ready for viewing on the user device 202 when a user requests—e.g., when the user requests the live video in the live video request 240.

In some cases, one or more models of the prediction engine 212 include classifier models. For example, the one or more models can be trained to determine whether or not a current video will be watched for more or less than a specified amount of time—e.g., 5 seconds. The specified amount of time can be adjusted dynamically, e.g., in response to training the one or more models for that particular threshold amount of time. In some cases, the system 200 performs AB testing using various threshold amounts of time to determine an amount of time that is optimal for preloading—e.g., that reduces corresponding bandwidth usage and processor usage more than at least one other threshold amount of time tested in AB testing. Suitable network structures-such as a multi-layer perceptron (MLP), recurrent neural networks, transformer networks, or a combination of these among others—can be used for the one or more models. The one or more models can generate predictions using data representing user history feed watch features, video features, user preference score features, or a combination of these among others. Data used by the prediction engine 212 can include features that indicate various attributes of a user's current or past content consumption, e.g., WiFi or other network signal, user device type, device available resources, popularity of content to be preloaded or current feed, server requests for the given content, user preference on live streams—e.g., whether a user watches or does not typically watch live streams. Data used by the prediction engine 212 can include user interaction data—e.g., data indicating whether or not a user interacts, such as by liking or commenting, with a watched video or other media.

The one or more models can be trained using training data that includes data associated with a set of one or more users where the data indicates a video and information identifying the corresponding user. Video data can include feature vectors that represent aspects of a video—e.g., if the video includes a type of music, a type of scene, color, movement, or a combination of these among others. Identifying information can include demographic information of the user, history data, such as features of historically viewed videos, watch duration of historical videos, preferences of a user, or a combination of these among others.

Ground truth labels used for training one or more models of the prediction engine 212 can include data that represents the actual amount of time a user spent watching a video. The one or more models of the prediction engine 212 can predict whether or not a user, based on historically obtained data of the user, will watch a video for more or less than a predetermined amount of time. The prediction can be compared with an actual time spent watching, e.g., recorded by the platform, to determine if the prediction of the prediction engine 212 is correct or incorrect. A training system, such as the system 200, can use a comparison of the actual time spent watching and the prediction to determine one or more adjustments to parameters of the one or more models of the prediction engine 212.

In some cases, the one or more models of the prediction engine 212 use a Rectified Linear Unit (ReLU) or sigmoid function. In some cases, the one or more models of the prediction engine 212 use binary cross entropy to determine loss for training. In some cases, the one or more models of the prediction engine 212 include six fully connected layers.

In some cases, the prediction engine 212 generates a prediction repeatedly. For example, while a prerecorded video prior to the live video 222 in the batch 209 is displayed on the user device 202, the prediction engine 212 can predict whether the user will request the live video in the next T seconds, where T can be any number. If the prediction indicates yes, then the platform 206 can preload data for the live video 222. If the prediction indicates no, then the platform 206 can skip preloading and wait a period of time, e.g., T seconds. After the waiting period, the prediction engine 212 can again predict whether the user is likely to request the live video in the next T seconds. In some cases, the prediction engine 212 only operates during a prerecorded video that is scheduled to be played immediately before a live video in a batch of videos—e.g., the prediction engine 212 only operates during the video 218 which is immediately prior to the live video 222 in the batch 209.

In some cases, the prediction engine 212 repeatedly generates predictions until a threshold number of predictions have been generated. For example, after three predictions, the platform 206 can stop predicting without preloading. In this way, the system 200 can save processing cycles by restricting the number of prediction generations of the prediction engine 212.

In the example of FIG. 2, the prediction engine 212 generates the preloading data 230. The preloading data 230 indicates when, or if, preloading of content is to begin. The prediction engine 212 can provide the preloading data 230 to the preloading engine 232. The preloading engine 232 can obtain the preloading data 230 can preload the relevant content—e.g., specified by the preloading data 230. In some cases, the preloading engine 232 preloads content by moving data from a data source 234 to a content buffer 236. As discussed, the elements of the platform 206, like the platform 106 and the user device 102, can be performed on the user device 202, at least partially, or on connected components, such as servers, distributed systems, or the like.

In some cases, the preloading engine 232 provides data from the data source 234 where the data source 234 is stored on a server, another user device, or the user device 202. In some cases, the content buffer 236 is included, at least partially, on memory devices of the user device 202—e.g., where the portion of the content buffer 236 on the user device 202 is used to provide the live video 242 in response to the live video request 240.

In some cases, the prediction engine 212 determines that no preloading should occur. In that case, the live video 222 can be loaded after receiving the live video request 240. For example, the preloading data 230 can indicate that no preloading should occur. The preloading engine 232 can, in response to the live video request 240, load data indicating a live feed of the live video 222 from the data source 234 to the content buffer 236 and provide data of the live video 242 from the content buffer 236 to a display of the user device 202. As discussed, requests from the user device 202 can include interactions performed by a user, such as swiping up on a touch screen, shaking the user device 202, dictation, among others.

In some cases, techniques can include selecting a resolution of a video that aligns with a user preference between video resolution and video smoothness, based, for example, on the bandwidth of the user's network or available resolutions of transcoded versions of the video files to be provided to the user device. In some cases, the user preference can be determined from a video playback history associated with the user. A return of interest (ROI) value associated with the preference of the user can be determined for each available resolution of a transcoded video. The ROI represents a total interest of the user in the particular video playback. The ROI at a particular resolution can be calculated based a combination of a perceived video quality provided by the given resolution, a video smoothness, and network resources needed to deliver the video content at the given resolution. The transcoded version of the video corresponding to the resolution that results in the largest ROI can then be selected for providing to the user device for playback. By adapting video resolution, user experience of video playback can be improved.

The system 100 and 200 are examples of systems that can be implemented as computer programs on one or more computers in one or more locations, in which the systems, components, and techniques described in this specification are implemented. The user devices 102 and 202 can include personal computers, mobile communication devices, and other devices that can send and receive data over a network. The network (not shown), such as a local area network (“LAN”), wide area network (“WAN”), the Internet, or a combination thereof, can connect the user devices with other elements of the systems. The systems 100 and 200 can use a single computer or multiple computers operating in conjunction with one another, including, for example, a set of remote computers deployed as a cloud computing service.

The systems 100 and 200 can include several different functional components, including component engines that operate on the platforms 106 and 206. The functional components can include one or more data processing apparatuses, can be implemented in code, or a combination of both. For instance, each of the components can include one or more data processors and instructions that cause the one or more data processors to perform the operations discussed herein.

The various functional components of the systems 100 and 200 can be installed on one or more computers as separate functional components or as different modules of a same functional component. For example, the components of the systems 100 and 200 can be implemented as computer programs installed on one or more computers in one or more locations that are coupled to each through a network. In cloud-based systems for example, these components can be implemented by individual computing nodes of a distributed computing system.

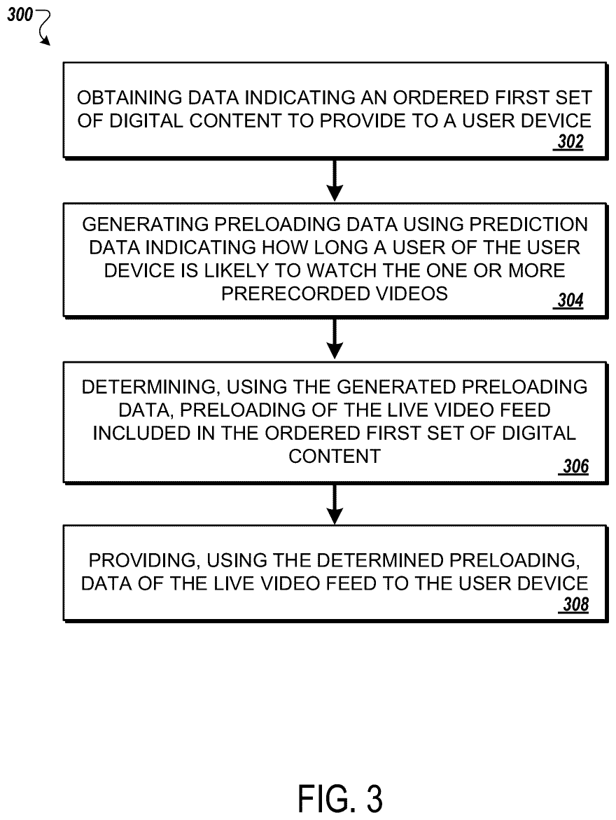

FIG. 3 is a flowchart of an example preloading process 300. For convenience, the process 300 will be described as being performed by a system of one or more computers, located in one or more locations, and programmed appropriately in accordance with this specification. For example, the system 100 of FIG. 1 or the system 200 of FIG. 2, appropriately programmed, can perform the process 300.

The process 300 includes obtaining data indicating an ordered first set of digital content to provide to a user device (302). For example, the ordered first set of digital content can include one or more prerecorded videos and a live video feed. The live video feed can follow the one or more prerecorded videos in the ordered first set of digital content. For example, the prediction engine 212 of FIG. 2 can obtain the batch 209 from the recommendation engine 208.

The process 300 includes generating preloading data using prediction data indicating how long a user of the user device is likely to watch the one or more prerecorded videos (304). For example, the prediction engine 212 can generate the preloading data 230. In some cases, the prediction engine 212 includes one or more machine learning models. The machine learning models can perform classifier or regression operations—e.g., classifying whether or not a user will likely watch a video more than a determined amount of time or predicting an amount of time a user is likely to watch. In some cases, using classifier operations can improve accuracy of prediction compared to regression operations. Prediction data can include historical viewing data or preferences of the user of the user device, a device identifier, a time of day, a currently joined network, device status, notification settings, profile information, among others. In general, any data obtained by the platform 206 indicating actions or preferences by a user can be used as prediction data for generated preloading data.

The process 300 includes determining, using the generated preloading data, preloading of the live video feed included in the ordered first set of digital content (306). For example, the preloading engine 232 can obtain the preloading data 230 and determine preloading of the live video feed 222 in the batch 209. Preloading can include obtaining data from the data source 234 representing a live video feed. For example, a live video feed can be transmitted by a user device to a component of the platform 206. The platform 206 can determine preloading of live video feed data for a user device by identifying and accessing data stored within one or more components of the platform 206, e.g., the data source 234. The data source 234 can include one or more memory devices communicably connected to the platform 206. The data source 234 can include a user device sharing live video feed where the live video feed is shared via the platform 206 accessing a memory device of the user device sharing the live video feed. Determining preloading can include the platform 206 generating one or more data packets by accessing one or more memory devices, such as one or more memory devices represented by the data source 234. The platform 206 can provide the generated data to a user device.

The process 300 includes providing, using the determined preloading, data of the live video feed to the user device (308). For example, the live video 242 can be provided by the platform 206 to the user device 202. Providing the live video 242 can include transferring data from one memory device of the platform 206 to a memory device stored locally on the user device 202—e.g., cache memory. Once the platform 206 provides the data to the memory device stored locally on the user device 202, the platform 206, e.g., via software stored on the user device 202, can obtain a request from a user to display a live video. In response to obtaining the request, such as the live video request 240, the platform 206 can display the preloaded live video 242 using a display of the user device 202.

The order of operations in the process 300 described above is illustrative only, and can be performed in different orders in some cases. In some implementations, the process 300 can include additional operations, fewer operations, or some of the operations can be divided into multiple operations.

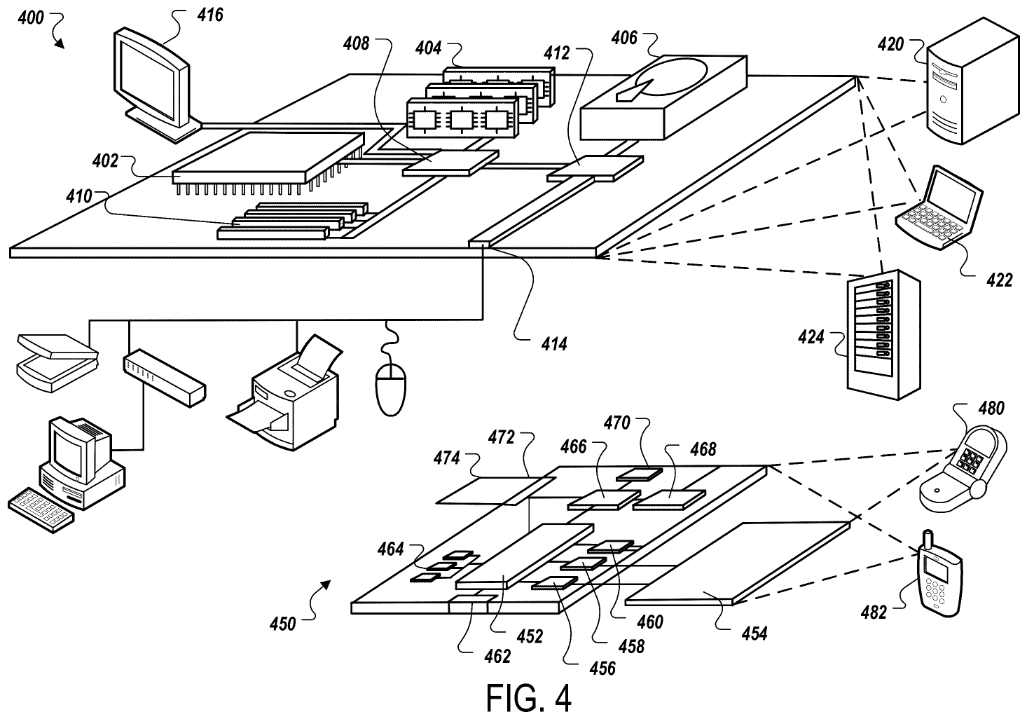

FIG. 4 is a block diagram of a computing system that can be used in connection with computer-implemented methods described in this specification. The computing system includes computing device 400 and a mobile computing device 450 that can be used to implement the techniques described herein. For example, one or more components of the system 100 or 200 could be an example of the computing device 400 or the mobile computing device 450.

The computing device 400 is intended to represent various forms of digital computers, such as laptops, desktops, workstations, personal digital assistants, servers, blade servers, mainframes, and other appropriate computers. The mobile computing device 450 is intended to represent various forms of mobile devices, such as personal digital assistants, cellular telephones, smart-phones, mobile embedded radio systems, radio diagnostic computing devices, and other similar computing devices. The components shown here, their connections and relationships, and their functions, are meant to be examples only, and are not meant to be limiting.

The computing device 400 includes a processor 402, a memory 404, a storage device 406, a high-speed interface 408 connecting to the memory 404 and multiple high-speed expansion ports 410, and a low-speed interface 412 connecting to a low-speed expansion port 414 and the storage device 406. Each of the processor 402, the memory 404, the storage device 406, the high-speed interface 408, the high-speed expansion ports 410, and the low-speed interface 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as a display 416 coupled to the high-speed interface 408. In other implementations, multiple processors and/or multiple buses may be used, as appropriate, along with multiple memories and types of memory. In addition, multiple computing devices may be connected, with each device providing portions of the operations (e.g., as a server bank, a group of blade servers, or a multi-processor system). In some implementations, the processor 402 is a single threaded processor. In some implementations, the processor 402 is a multi-threaded processor. In some implementations, the processor 402 is a quantum computer.

The memory 404 stores information within the computing device 400. In some implementations, the memory 404 is a volatile memory unit or units. In some implementations, the memory 404 is a non-volatile memory unit or units. The memory 404 may also be another form of computer-readable medium, such as a magnetic or optical disk.

The storage device 406 is capable of providing mass storage for the computing device 400. In some implementations, the storage device 406 may be or include a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, processor 402), perform one or more methods, such as those described above. The instructions can also be stored by one or more storage devices such as computer- or machine-readable mediums (for example, the memory 404, the storage device 406, or memory on the processor 402). The high-speed interface 408 manages bandwidth-intensive operations for the computing device 400, while the low-speed interface 412 manages lower bandwidth-intensive operations. Such allocation of functions is an example only. In some implementations, the high-speed interface 408 is coupled to the memory 404, the display 416 (e.g., through a graphics processor or accelerator), and to the high-speed expansion ports 410, which may accept various expansion cards (not shown). In the implementation, the low-speed interface 412 is coupled to the storage device 406 and the low-speed expansion port 414. The low-speed expansion port 414, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. In addition, it may be implemented in a personal computer such as a laptop computer 422. It may also be implemented as part of a rack server system 424. Alternatively, components from the computing device 400 may be combined with other components in a mobile device, such as a mobile computing device 450. Each of such devices may include one or more of the computing device 400 and the mobile computing device 450, and an entire system may be made up of multiple computing devices communicating with each other.

The mobile computing device 450 includes a processor 452, a memory 464, an input/output device such as a display 454, a communication interface 466, and a transceiver 468, among other components. The mobile computing device 450 may also be provided with a storage device, such as a micro-drive or other device, to provide additional storage. Each of the processor 452, the memory 464, the display 454, the communication interface 466, and the transceiver 468, are interconnected using various buses, and several of the components may be mounted on a common motherboard or in other manners as appropriate.

The processor 452 can execute instructions within the mobile computing device 450, including instructions stored in the memory 464. The processor 452 may be implemented as a chipset of chips that include separate and multiple analog and digital processors. The processor 452 may provide, for example, for coordination of the other components of the mobile computing device 450, such as control of user interfaces, applications run by the mobile computing device 450, and wireless communication by the mobile computing device 450.

The processor 452 may communicate with a user through a control interface 458 and a display interface 456 coupled to the display 454. The display 454 may be, for example, a TFT (Thin-Film-Transistor Liquid Crystal Display) display or an OLED (Organic Light Emitting Diode) display, or other appropriate display technology. The display interface 456 may include appropriate circuitry for driving the display 454 to present graphical and other information to a user. The control interface 458 may receive commands from a user and convert them for submission to the processor 452. In addition, an external interface 462 may provide communication with the processor 452, so as to enable near area communication of the mobile computing device 450 with other devices. The external interface 462 may provide, for example, for wired communication in some implementations, or for wireless communication in other implementations, and multiple interfaces may also be used.

The memory 464 stores information within the mobile computing device 450. The memory 464 can be implemented as one or more of a computer-readable medium or media, a volatile memory unit or units, or a non-volatile memory unit or units. An expansion memory 474 may also be provided and connected to the mobile computing device 450 through an expansion interface 472, which may include, for example, a SIMM (Single In Line Memory Module) card interface. The expansion memory 474 may provide extra storage space for the mobile computing device 450, or may also store applications or other information for the mobile computing device 450. Specifically, the expansion memory 474 may include instructions to carry out or supplement the processes described above, and may include secure information also. Thus, for example, the expansion memory 474 may be provide as a security module for the mobile computing device 450, and may be programmed with instructions that permit secure use of the mobile computing device 450. In addition, secure applications may be provided via the SIMM cards, along with additional information, such as placing identifying information on the SIMM card in a non-hackable manner.

The memory may include, for example, flash memory and/or NVRAM memory (nonvolatile random access memory), as discussed below. In some implementations, instructions are stored in an information carrier such that the instructions, when executed by one or more processing devices (for example, processor 452), perform one or more methods, such as those described above. The instructions can also be stored by one or more storage devices, such as one or more computer- or machine-readable mediums (for example, the memory 464, the expansion memory 474, or memory on the processor 452). In some implementations, the instructions can be received in a propagated signal, for example, over the transceiver 468 or the external interface 462.

The mobile computing device 450 may communicate wirelessly through the communication interface 466, which may include digital signal processing circuitry in some cases. The communication interface 466 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), LTE, 4G/6G cellular, among others. Such communication may occur, for example, through the transceiver 468 using a radio frequency. In addition, short-range communication may occur, such as using a Bluetooth, Wi-Fi, or other such transceiver (not shown). In addition, a GPS (Global Positioning System) receiver module 470 may provide additional navigation—and location-related wireless data to the mobile computing device 450, which may be used as appropriate by applications running on the mobile computing device 450.

The mobile computing device 450 may also communicate audibly using an audio codec 460, which may receive spoken information from a user and convert it to usable digital information. The audio codec 460 may likewise generate audible sound for a user, such as through a speaker, e.g., in a handset of the mobile computing device 450. Such sound may include sound from voice telephone calls, may include recorded sound (e.g., voice messages, music files, among others) and may also include sound generated by applications operating on the mobile computing device 450.

The mobile computing device 450 may be implemented in a number of different forms, as shown in the figure. For example, it may be implemented as a cellular telephone 480. It may also be implemented as part of a smart-phone 482, personal digital assistant, or other similar mobile device.

In general, use of “or” can refer to “and/or.” When providing a list of two or more items, the conjunction “or” can indicate any one of the items, any combination of a subset of the items, or all items in combination.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
obtaining data indicating an ordered first set of digital content to provide to a user device, the ordered first set of digital content comprising (i) one or more prerecorded videos and (ii) a live video feed, wherein the live video feed follows the one or more prerecorded videos in the ordered first set of digital content;
generating preloading data using prediction data indicating how long a user of the user device is likely to watch the one or more prerecorded videos;
using the generated preloading data, determining preloading of the live video feed included in the ordered first set of digital content; and
providing, using the determined preloading, data of the live video feed to the user device.

2. The method of claim 1, wherein generating the preloading data comprises:
generating a classification for the one or more prerecorded videos in the ordered first set of digital content.

3. The method of claim 2, wherein generating the classification comprises:
determining whether or not the user of the user device is likely to watch the one or more prerecorded videos for a specified period of time.

4. The method of claim 1, wherein generating the preloading data comprises:
generating a first classification for the one or more prerecorded videos in the ordered first set of digital content indicating whether or not the user of the user device is likely to watch the one or more prerecorded videos for a first specified period of time;
in response to the first classification indicating that the user of the user device is likely to watch the one or more prerecorded videos for more than or equal to the first specified period of time, waiting for a waiting duration period; and
after waiting for the waiting duration period, generating a second classification for the one or more prerecorded videos in the ordered first set of digital content indicating whether or not the user of the user device is likely to watch the one or more prerecorded videos for a second specified period of time.

5. The method of claim 4, wherein the waiting duration period is equal to the first specified period of time.

6. The method of claim 1, wherein generating the preloading data comprises generating the preloading data using a machine learning model trained to predict an indication of how long the user of the user device is likely to watch the one or more prerecorded videos.

7. The method of claim 6, comprising:
training the machine learning model using training data that comprises (i) user associated data for users that have watched one or more videos, (ii) data representing features of the one or more videos, and (iii) ground truth data representing known watch times for the one or more videos by the users represented in the user associated data.

8. The method of claim 1, comprising:
providing at least a portion of the one or more prerecorded videos to the user device while providing the data of the live video feed to the user device.

9. The method of claim 1, comprising:
providing at least a portion of the one or more prerecorded videos to the user device prior to providing the data of the live video feed to the user device.

10. One or more computer-readable storage media encoded with instructions that, when executed by one or more computers, cause the one or more computers to perform operations comprising:
obtaining data indicating an ordered first set of digital content to provide to a user device, the ordered first set of digital content comprising (i) one or more prerecorded videos and (ii) a live video feed, wherein the live video feed follows the one or more prerecorded videos in the ordered first set of digital content;
generating preloading data using prediction data indicating how long a user of the user device is likely to watch the one or more prerecorded videos;
using the generated preloading data, determining preloading of the live video feed included in the ordered first set of digital content; and
providing, using the determined preloading, data of the live video feed to the user device.

11. The media of claim 10, wherein generating the preloading data comprises:
generating a classification for the one or more prerecorded videos in the ordered first set of digital content.

12. The media of claim 11, wherein generating the classification comprises:
determining whether or not the user of the user device is likely to watch the one or more prerecorded videos for a specified period of time.

13. The media of claim 10, wherein generating the preloading data comprises:
generating a first classification for the one or more prerecorded videos in the ordered first set of digital content indicating whether or not the user of the user device is likely to watch the one or more prerecorded videos for a first specified period of time;
in response to the first classification indicating that the user of the user device is likely to watch the one or more prerecorded videos for more than or equal to the first specified period of time, waiting for a waiting duration period; and
after waiting for the waiting duration period, generating a second classification for the one or more prerecorded videos in the ordered first set of digital content indicating whether or not the user of the user device is likely to watch the one or more prerecorded videos for a second specified period of time.

14. The media of claim 13, wherein the waiting duration period is equal to the first specified period of time.

15. The media of claim 10, wherein generating the preloading data comprises generating the preloading data using a machine learning model trained to predict an indication of how long the user of the user device is likely to watch the one or more prerecorded videos.

16. The media of claim 15, wherein the operations comprise:
training the machine learning model using training data that comprises (i) user associated data for users that have watched one or more videos, (ii) data representing features of the one or more videos, and (iii) ground truth data representing known watch times for the one or more videos by the users represented in the user associated data.

17. The media of claim 10, wherein the operations comprise:
providing at least a portion of the one or more prerecorded videos to the user device while providing the data of the live video feed to the user device.

18. The media of claim 10, wherein the operations comprise:
providing at least a portion of the one or more prerecorded videos to the user device prior to providing the data of the live video feed to the user device.

19. A system comprising:
one or more computers and one or more storage devices on which are stored instructions that are operable, when executed by the one or more computers, to cause the one or more computers to perform operations comprising:
obtaining data indicating an ordered first set of digital content to provide to a user device, the ordered first set of digital content comprising (i) one or more prerecorded videos and (ii) a live video feed, wherein the live video feed follows the one or more prerecorded videos in the ordered first set of digital content;
generating preloading data using prediction data indicating how long a user of the user device is likely to watch the one or more prerecorded videos;
using the generated preloading data, determining preloading of the live video feed included in the ordered first set of digital content; and
providing, using the determined preloading, data of the live video feed to the user device.

20. The system of claim 19, wherein generating the preloading data comprises:
generating a classification for the one or more prerecorded videos in the ordered first set of digital content.
